(19) United States
(12) Patent Application Publication
(10) Pub. No.: US 2014/0250078 A1
(43) Pub. Date: Sep. 4, 2014

(54) MULTIPHASE DEDUPLICATION

(71) Applicant: STORAGECRAFT TECHNOLOGY CORPORATION, Draper, UT (US)

(72) Inventor: Andrew Lynn Gardner, Salt Lake City, UT (US)

(73) Assignee: STORAGECRAFT TECHNOLOGY CORPORATION, Draper, UT (US)

(21) Appl. No.: 13/782,549

(22) Filed: Mar. 1, 2013

(51) Int. Cl. G06F 17/30

(52) U.S. Cl. CPC G06F 17/30156
USPC 707/646

(57) ABSTRACT

Multiphase deduplication. In one example embodiment, a method of multiphase deduplication includes an analysis phase and a backup phase. The analysis phase includes analyzing each allocated block stored in a source storage at a point in time to determine if the block is duplicated in a vault storage. The backup phase is performed after completion of the analysis phase and includes storing, in the vault storage, each unique nonduplicate block from the source storage.

### FIELD

The embodiments disclosed herein relate to multiphase deduplication performed during the creation of backups of storages.

### BACKGROUND

A storage is computer-readable media capable of storing data in blocks. Storages face a myriad of threats to the data they store and to their smooth and continuous operation. In order to mitigate these threats, a backup of the data in a storage may be created at a particular point in time to enable the restoration of the data at some future time. Such a restoration may become desirable, for example, if the storage experiences corruption of its stored data, if the storage becomes unavailable, or if a user wishes to create a second identical storage.

A storage is typically logically divided into a finite number of fixed-length blocks. A storage also typically includes a file system which tracks the locations of the blocks that are allocated to each file that is stored in the storage. The file system also tracks the blocks that are not allocated to any file. The file system generally tracks allocated and unallocated blocks using specialized data structures, referred to as file system metadata. File system metadata is also stored in designated blocks in the storage.

Various techniques exist for backing up a source storage. One common technique involves backing up individual files stored in the source storage on a per-file basis. This technique is often referred to as file backup. File backup uses the file system of the source storage as a starting point and performs a backup by writing the files to a backup storage. Using this approach, individual files are backed up if they have been modified since the previous backup. File backup may be useful for finding and restoring a few lost or corrupted files. However, file backup may also include significant overhead in the form of bandwidth and logical overhead because file backup requires the tracking and storing of information about where each file exists within the file system of the source storage and the backup storage.

Another common technique for backing up a source storage ignores the locations of individual files stored in the source storage and instead simply backs up all allocated blocks stored in the source storage. This technique is often referred to as image backup because the backup generally contains or represents an image, or copy, of the entire allocated contents of the source storage. Using this approach, individual allocated blocks are backed up if they have been modified since the previous backup. Because image backup backs up all allocated blocks of the source storage, image backup backs up both the blocks that make up the files stored in the source storage as well as the blocks that make up the file system metadata. Also, because image backup backs up all allocated blocks rather than individual files, this approach does not necessarily need to be aware of the file system metadata or the files stored in the source storage, beyond utilizing minimal knowledge of the file system metadata in order to only back up allocated blocks since unallocated blocks are not generally backed up.

An image backup can be relatively fast compared to file backup because reliance on the file system is minimized. An image backup can also be relatively fast compared to a file backup because seeking is reduced. In particular, during an image backup, blocks are generally read sequentially with relatively limited seeking. In contrast, during a file backup, blocks that make up individual files may be scattered, resulting in relatively extensive seeking.

One common problem encountered when backing up multiple similar source storages to the same backup storage using image backup is the potential for redundancy within the backed-up data. For example, if multiple source storages utilize the same commercial operating system, such as WINDOWS® XP Professional, they may store a common set of system files which will have identical blocks. If these source storages are backed up to the same backup storage, these identical blocks will be stored in the backup storage multiple times, resulting in redundant blocks. Redundancy in a backup storage may increase the overall size requirements of the backup storage and increase the bandwidth overhead of transporting data to the backup storage.

The subject matter claimed herein is not limited to embodiments that solve any disadvantages or that operate only in environments such as those described above. Rather, this background is only provided to illustrate one example technology area where some embodiments described herein may be practiced.

### SUMMARY

In general, example embodiments described herein relate to multiphase deduplication performed during the creation of backups of storages. The example methods disclosed herein may be employed to eliminate duplicate data in the backups of source storages stored in a vault storage. The multiple phases of the example methods disclosed herein may also result in decreased fragmentation of the data in the vault storage, resulting in increased efficiency and speed during the restoration of each backup.

In one example embodiment, a method of multiphase deduplication includes an analysis phase and a backup phase. The analysis phase includes analyzing each allocated block stored in a source storage at a point in time to determine if the block is duplicated in a vault storage. The backup phase is performed after completion of the analysis phase and includes storing, in the vault storage, each unique nonduplicate block from the source storage.

In another example embodiment, a method of multiphase deduplication includes an analysis phase and a backup phase. The analysis phase includes performing the following steps for each allocated block stored in a source storage at a point in time: reading the block from the source storage, determining whether the block is duplicated in a vault storage, and associating a location of the block stored in the source storage with a location of the corresponding duplicated block stored in the vault storage if the block is duplicated in the vault storage. The backup phase includes performing, after completion of the analysis phase, the following steps for each unique nonduplicate block stored in the source storage: reading the block from the source storage, storing the block in the vault storage, and associating a location of the block stored in the source storage with a location of the corresponding block stored in the vault storage.

In yet another example embodiment, a method of multiphase deduplication includes an analysis phase and a backup phase. The analysis phase includes performing the following steps for each allocated block stored in a source storage at a point in time: reading the block from the source storage, determining whether the block is duplicated in a vault storage, and associating a location of the block stored in the source storage with a location of the corresponding duplicated block stored in the vault storage if the block is stored in the vault storage. The backup phase includes performing, after completion of the analysis phase, the following steps for all unique nonduplicate runs in the source storage: reading the runs from the source storage, storing the runs in the vault storage in the same sequence as stored in the source storage at the point in time, and associating a location of each run stored in the source storage with a corresponding location of the run stored in the vault storage.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a schematic block diagram illustrating an example deduplication backup system including an example deduplication vault system;

FIG. 2 is a schematic flowchart illustrating an example method for creating a base backup and multiple incremental backups of a source storage;

FIG. 3A is a schematic flowchart illustrating the creation of an example base backup;

FIG. 3B is a schematic flowchart illustrating the creation of an example incremental backup;

FIG. 4 is a schematic block diagram illustrating an example database element;

FIG. 5 is a schematic block diagram illustrating an example database configured to track the locations of blocks stored within the example deduplication vault system of FIG. 1;

FIG. 6 is a schematic block diagram illustrating an example metadata node;

FIG. 7 is a schematic block diagram illustrating an example metadata configured to track individual backups stored within the example deduplication vault system of FIG. 1; and

FIG. 8 is a schematic flowchart diagram of an example method of multiphase deduplication.

### DESCRIPTION OF EMBODIMENTS

Some embodiments described herein include multiphase deduplication performed during the creation of backups of storages. The example methods disclosed herein may be employed to eliminate duplicate data in the backups of source storages stored in a vault storage. The multiple phases of the example methods disclosed herein may also result in decreased fragmentation of the data in the vault storage, resulting in increased efficiency and speed during the restoration of each backup.

The term “storage” as used herein refers to computer-readable media, or some logical portion thereof such as a volume, capable of storing data in blocks. The term “block” as used herein refers to a fixed-length discrete sequence of bits. The term “run” as used herein refers to one or more blocks stored sequentially on a storage. The term “backup” when used herein as a noun refers to a copy or copies of one or more blocks from a storage.

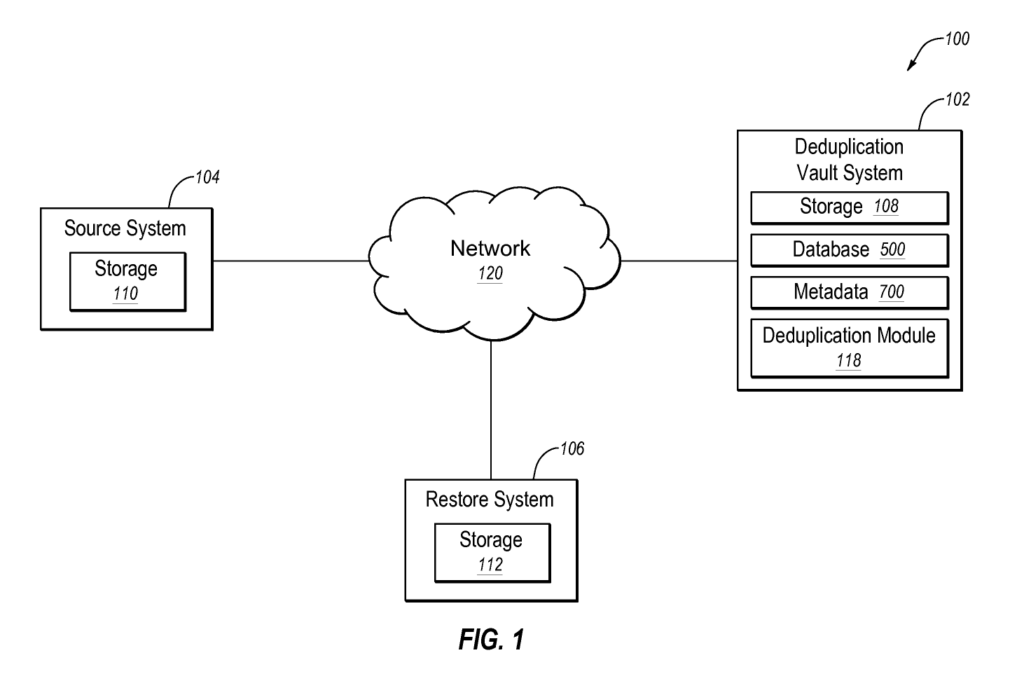

FIG. 1 is a schematic block diagram illustrating an example deduplication backup system 100. As disclosed in FIG. 1, the example system 100 includes a deduplication vault system 102, a source system 104, and a restore system 106. The systems 102, 104, and 106 include storages 108, 110, and 112, respectively. The deduplication vault system 102 also includes a database 500, metadata 700, and a deduplication module 118. The systems 102, 104, and 106 are able to communicate with one another over a network 120.

Each system 102, 104, and 106 may be any computing device capable of supporting a storage and communicating with other systems including, for example, file servers, web servers, personal computers, desktop computers, laptop computers, handheld devices, multiprocessor systems, microprocessor-based or programmable consumer electronics, smartphones, digital cameras, hard disk drives, and flash memory drives. The network 120 may be any wired or wireless communication network including, for example, a Local Area Network (LAN), a Metropolitan Area Network (MAN), a Wide Area Network (WAN), a Wireless Application Protocol (WAP) network, a Bluetooth network, an Internet Protocol (IP) network such as the internet, or some combination thereof.

During performance of the example methods disclosed herein, the deduplication module 118 may analyze, during one phase, the allocated blocks stored in the source storage 110 at a point in time to determine if the allocated blocks are already duplicated in the vault storage 108 and then back up, during a subsequent phase, those blocks from the source storage 110 that do not already have duplicate blocks stored in the vault storage 108. Subsequently, the deduplication module 118 may restore, during another subsequent phase, each block that was stored in the source storage 110 at the point in time to the restore storage 112. The database 500 and the metadata 700 may be employed to track information related to the source storage 110, the vault storage 108, and the backup of the source storage 110 that is stored in the vault storage 108. As discussed in greater detail below, completing the analysis of the allocated blocks stored in the source storage 110, in one phase, prior to the backing up of the nonduplicate blocks in the vault storage 108, in a subsequent phase, may result in decreased fragmentation of the backed-up blocks in the vault storage 108, resulting in increased efficiency and speed during the restoration of the blocks to the restore storage 112.

In one example embodiment, the deduplication vault system 102 may be a file server, the source system 104 may be a first desktop computer, the restore system 106 may be a second desktop computer, and the network 120 may include the internet. In this example embodiment, the file server may be configured to periodically back up the storage of the first desktop computer over the internet. The file server may then be configured to restore the most recent backup to the storage of the second desktop computer over the internet if the first desktop computer experiences corruption of its storage or if the first desktop computer's storage becomes unavailable.

Although only a single storage is disclosed in each of the systems 102, 104, and 106 in FIG. 1, it is understood that any of the systems 102, 104, or 106 may instead include two or more storages. Further, although the systems 102, 104, and 106 are disclosed in FIG. 1 as communicating over the network 120, it is understood that the systems 102, 104, and 106 may instead communicate directly with each other. For example, in some embodiments any combination of the systems 102, 104, and 106 may be combined into a single system. Also, although the storages 108, 110, and 112 are disclosed as separate storages, it is understood that any combination of the storages 108, 110, and 112 may be combined into a single storage. For example, in some embodiments the storage 110 may function as both a source storage during the creation of a backup and a restore storage during a restore of the backup, which may enable the storage 110 to be restored to a state of an earlier point in time. Further, although the deduplication module 118 is the only module disclosed in the example deduplication backup system 100 of FIG. 1, it is understood that the functionality of the deduplication module 118 may be replaced or augmented by one or more similar modules residing on any of the systems 102, 104, and 106. Finally, although only a single source storage and a single restore storage are disclosed in the example deduplication backup system 100 of FIG. 1, it is understood that the deduplication vault system 102 of FIG. 1 is configured to simultaneously back up or restore multiple source storages. For example, the greater the number of storages that are backed up to the vault storage 108 of the deduplication vault system 102, the greater the likelihood for reducing redundancy and overall size of the data being backed up, resulting in corresponding decreases in the bandwidth overhead of transporting data to the backup storage.

Having described one specific environment with respect to FIG. 1, it is understood that the specific environment of FIG. 1 is only one of countless environments in which the example methods disclosed herein may be employed. The scope of the example embodiments is not intended to be limited to any particular environment.

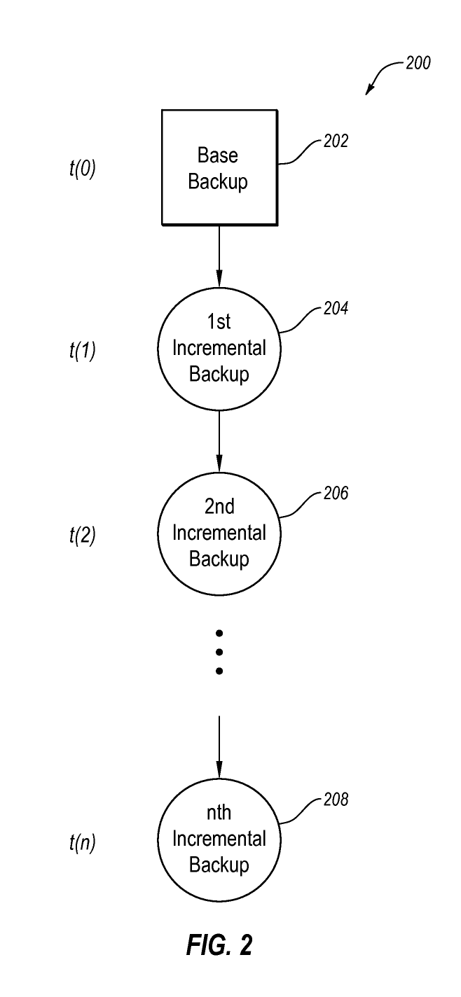

FIG. 2 is a schematic flowchart illustrating an example method 200 for creating a base backup and multiple incremental backups of a source storage. The method 200 may be implemented, in at least some embodiments, by the deduplication module 118 of the deduplication vault system 102 of FIG. 1. For example, the deduplication module 118 may be configured to execute computer instructions to perform operations of creating a base backup and multiple incremental backups of the source storage 110, as represented by one or more of steps 202-208 of the method 200. Although illustrated as discrete steps, various steps may be divided into additional steps, combined into fewer steps, or eliminated, depending on the desired implementation. The method 200 will now be discussed with reference to FIGS. 1 and 2.

The method 200 may begin at step 202, in which a base backup is created to capture the state at time t(0). For example, the deduplication module 118 may create a base backup of all allocated blocks of the source storage 110 as allocated at time t(0) and store the allocated blocks in the vault storage 108. The state of the source storage 110 at time t(0) may be captured using snapshot technology in order to capture the data stored in the source storage 110 at time t(0) without interrupting other processes, thus avoiding downtime of the source storage 110. The base backup may be very large depending on the size of the source storage 110 and the number of allocated blocks at time t(0). As a result, the base backup may take a relatively long time to create and consume a relatively large amount of space in the vault storage 108.

At steps 204 and 206, 1st and 2nd incremental backups are created to capture the states at times t(1) and t(2), respectively. For example, the deduplication module 118 may create a 1st incremental backup of only changed allocated blocks of the source storage 110 present at time t(1) and store the changed allocated blocks in the vault storage 108, then later create a 2nd incremental backup of only changed allocated blocks of the source storage 110 present at time t(2) and store the changed allocated blocks in the vault storage 108. The states of the source storage 110 at times t(1) and t(2) may again be captured using snapshot technology, thus avoiding downtime of the source storage 110. Each incremental backup includes only those allocated blocks from the source storage 110 that were changed after the time of the previous backup. Thus, the 1st incremental backup includes only those allocated blocks from the source storage 110 that changed between time t(0) and time t(1), and the 2nd incremental backup includes only those allocated blocks from the source storage 110 that changed between time t(1) and time t(2). In general, as compared to the base backup, each incremental backup may take a relatively short time to create and consume a relatively small storage space in the vault storage 108.

At step 208, an nth incremental backup is created to capture the state at time t(n). For example, the deduplication module 118 may create an nth incremental backup of only changed allocated blocks of the source storage 110 present at time t(n), using snapshot technology, and store the changed allocated blocks in the vault storage 108. The nth incremental backup includes only those allocated blocks from the source storage 110 that changed between time t(n) and time t(n−1).

As illustrated in the example method 200, incremental backups may be created on an ongoing basis. The frequency of creating new incremental backups may be altered as desired in order to adjust the amount of data that will be lost should the source storage 110 experience corruption of its stored data or become unavailable at any given point in time. The data from the source storage 110 can be restored to the state at the point in time of a particular incremental backup by applying the backups from oldest to newest, namely, first applying the base backup and then applying each successive incremental backup up to the particular incremental backup.

Although only allocated blocks are backed up in the example method 200, it is understood that in alternative implementations both allocated and unallocated blocks may be backed up during the creation of a base backup or an incremental backup. This is typically done for forensic purposes, because the contents of unallocated blocks can be interesting where the unallocated blocks contain data from a previous point in time when the blocks were in use and allocated. Therefore, the creation of base backups and incremental backups as disclosed herein is not limited to allocated blocks but may also include unallocated blocks.

Further, although only a base backup and incremental backups are created in the example method 200, it is understood that the source storage 110 may instead be backed up by creating a base backups and decremental backups. Decremental backups are created by initialing creating a base backup to capture the state at a previous point in time, then updating the base backup to capture the state at a subsequent point in time by modifying only those blocks in the base backup that changed between the previous and subsequent points in time. Prior to the updating of the base backup, however, the original blocks in the base backup that correspond to the changed blocks are copied to a decremental backup, thus enabling restoration of the source storage 110 at the previous point in time (by restoring the updated base backup and then restoring the decremental backup) or at the subsequent point in time (by simply restoring the updated base backup). Since restoring a single base backup is generally faster than restoring a base backup and one or more incremental or decremental backups, creating decremental backups instead of incremental backups may enable the most recent backup to be restored more quickly since the most recent backup is always a base backup or an updated base backup instead of potentially being an incremental backup. Therefore, the creation of backups as disclosed herein is not limited to a base backup and incremental backups but may also include a base backup and decremental backups.

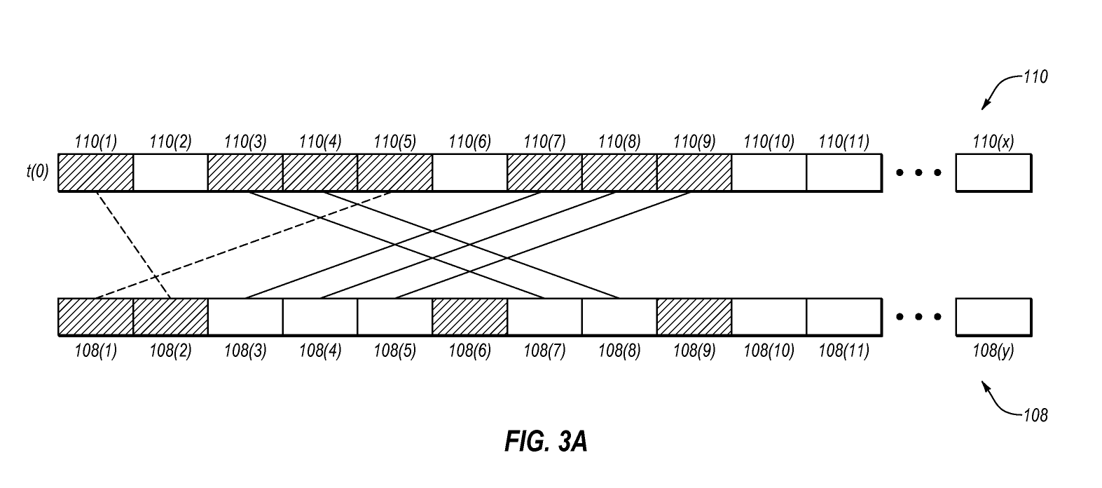

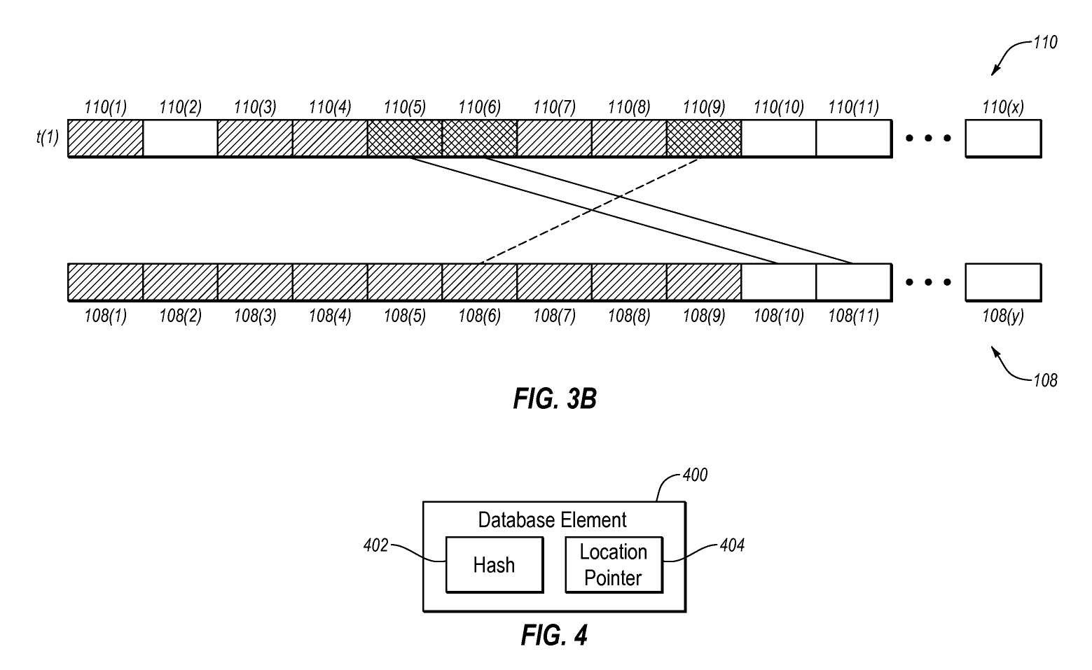

FIG. 3A is a schematic flowchart illustrating the creation of an example base backup and FIG. 3B is a schematic flowchart illustrating the creation of an example incremental backup. The creation of the base backup in FIG. 3A and the creation of the incremental backup in FIG. 3B may be performed, in at least some embodiments, by the deduplication module 118 of the deduplication vault system 102 of FIG. 1. For example, the deduplication module 118 may be configured to execute computer instructions to perform operations of creating a base backup of the source storage 110 and creating an incremental backup of the source storage 110.

As disclosed in FIGS. 3A and 3B, the source storage 110 is partitioned into a physical layout of blocks 110(1)-110(x), where x is the number of total blocks in the source storage 110. Similarly, the vault storage 108 is partitioned into a physical layout of blocks 108(1)-108(y), where y is the number of total blocks in the vault storage 108. In some example embodiments, the size of each block is 4096 bytes, although any other block size could instead be employed. The size of each block may be configured to match the standard sector size of a file system of the vault storage 108 and the source storage 110. In some example embodiments, y may be greater than x in order to allow multiple storages to be backed up in the vault storage 108. The hatched blocks in FIGS. 3A and 3B illustrate allocated blocks in the source storage 110, the cross-hatched blocks in FIG. 3B illustrate allocated blocks in the source storage 110 that changed between time t(0) and time t(1), and the blank blocks in FIGS. 3A and 3B illustrate unallocated blocks. The dashed lines in FIGS. 3A and 3B represent a determination that an allocated block from the source storage 110 is already duplicated in the vault storage 108. The solid lines in FIGS. 3A and 3B represent a determination that an allocated block from the source storage 110 is not duplicated in the vault storage 108.

As disclosed in FIG. 3A, a base backup may be created of the source storage 110 to capture the state at time t(0). During an analysis phase of the creation of the base backup of the source storage 110, the blocks 110(1) and 110(5) are determined to already be duplicated as blocks 108(2) and 108(1), respectively. Thus, there is no need to again store the blocks 110(1) and 110(5) in the vault storage 108. Conversely, the run 110(3)-110(4) and the run 110(7)-110(9) are determined during the analysis phase to be nonduplicate blocks. Therefore, during a backup phase of the creation of the base backup of the source storage 110, the run 110(3)-110(4) and the run 110(7)-110(9) are stored in the run 108(7)-108(8) and the run 108(3)-108(5), respectively, of the vault storage 108.

It is noted that the performance of the analysis phase prior to the performance of the backup phase may enable information about the source storage 110 to be gathered that can be used to decrease the fragmentation of the data in the vault storage 108. In particular, it may be determined during the analysis phase that runs exist in the nonduplicate blocks in the source storage 110. Identifying runs in the nonduplicate blocks prior to backing up the nonduplicate blocks may enable the identification of matching runs of unallocated blocks in the vault storage 108 so that the runs from the source storage 110 can be stored as runs in the vault storage 108 without being divided. This storing of runs in the vault storage 108 may be particularly useful during a subsequent restore phase because it reduces the time spent seeking the blocks that make up the backup of the source storage 110.

For example, if a run from the source storage 110 is stored as a run in a single location in the vault storage 108, restoring that particular run will require only a single seek operation. However, if the run from the source storage 110 is split up and stored in two separate locations in the vault storage 108, restoring that particular run will require two seek operations instead of one, thus potentially doubling the time spent during a restore phase seeking the blocks that make up the run.

This reduction in seek operations can be illustrated in FIG. 3A. As disclosed in FIG. 3A, the performance of the analysis phase before the performance of the backup phase enables the identification of nonduplicate allocated blocks in the run 110(3)-110(4) and the run 110(7)-110(9) of the source storage 110, and a corresponding identification of matching runs of unallocated blocks in the vault storage 108, namely, the run 108(7)-108(8) and the run 108(3)-108(5). However, if the analysis phase were not performed and the nonduplicate allocated blocks from the source storage 110 were simply stored sequentially in the first available unallocated block in the vault storage 108, the run 110(3)-110(4) would be stored in the run 108(3)-108(4), but then the block 110(7) of the run 110(7)-110(9) would be stored in the block 108(5) and the blocks 110(8) and 110(9) of the run 110(7)-110(9) would be stored in the next available unallocated blocks 108(7) and 108(8), thus splitting up the run 110(7)-110(9). The splitting up of the run 110(7)-110(9) in the vault storage 108 would require two seek operations instead of one during a restore of the run 110(7)-110(9), thus potentially doubling the time spent seeking the run 110(7)-110(9) during the restore.

It is understood that the scale of runs with lengths of two blocks and three blocks disclosed in FIG. 3A is for example purposes only, and in practice runs may have lengths of millions or even billions of blocks. With a longer run, the potential exists for the run being split into many different locations in a backup, and the maintenance of the run in a single location in the backup may thus avoid many extra seek operations.

As disclosed in FIG. 3B, an incremental backup may be created of the source storage 110 to capture the state at time t(1). The incremental backup of the source storage 110 will include only those allocated blocks from the source storage 110 that changed between time t(0) and time t(1). In particular, as time progresses after time t(0) but prior to time t(1), changes may occur to specific blocks on the source storage 110. When data within a block is changed, the block is then targeted for the next incremental backup. Thus, during an analysis phase of the creation of the incremental backup of the source storage 110, only the changed allocated blocks 110(5), 110(6), and 110(9) are analyzed. The changed allocated block 110(9) is determined to already be duplicated as block 108(6), and thus there is no need to again store changed allocated block 110(9) in the vault storage 108. Conversely, the changed allocated block 110(5), and the newly allocated, and therefore changed, block 110(6) are determined during the analysis phase to be nonduplicate blocks. Therefore, during a backup phase of the creation of the incremental backup of the source storage 110, the changed allocated blocks of the run 110(5)-110(6) are stored in the run 108(10)-108(11) of the vault storage 108.

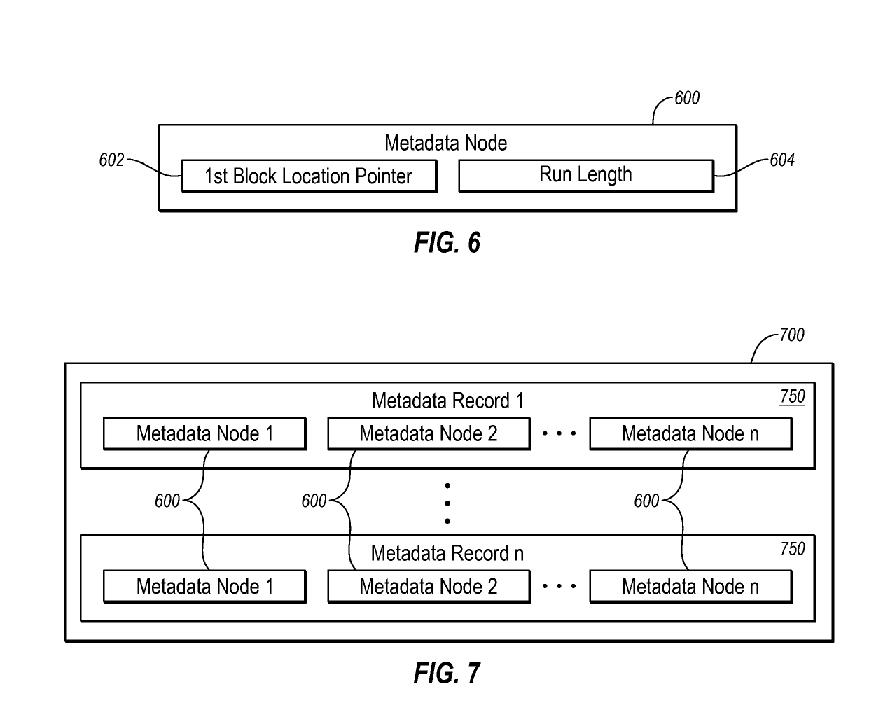

It is understood, as discussed in greater detail below, that the vault storage 108 is only configured to store a single copy of each unique block from the source storage 110. For example, if blocks 110(5) and 110(9) were identical in FIG. 3B, only a single unique copy of these two blocks would be stored in block 108(6) of the vault storage 108, although two separate metadata nodes 600 would appear in the metadata record 750 that corresponds to the backup of the source storage 110, as discussed below in connection with FIGS. 6 and 7. Therefore, the vault storage 108 is configured not only to avoid duplication of blocks across backups from separate storages, but also to avoid duplication of blocks within a single storage.

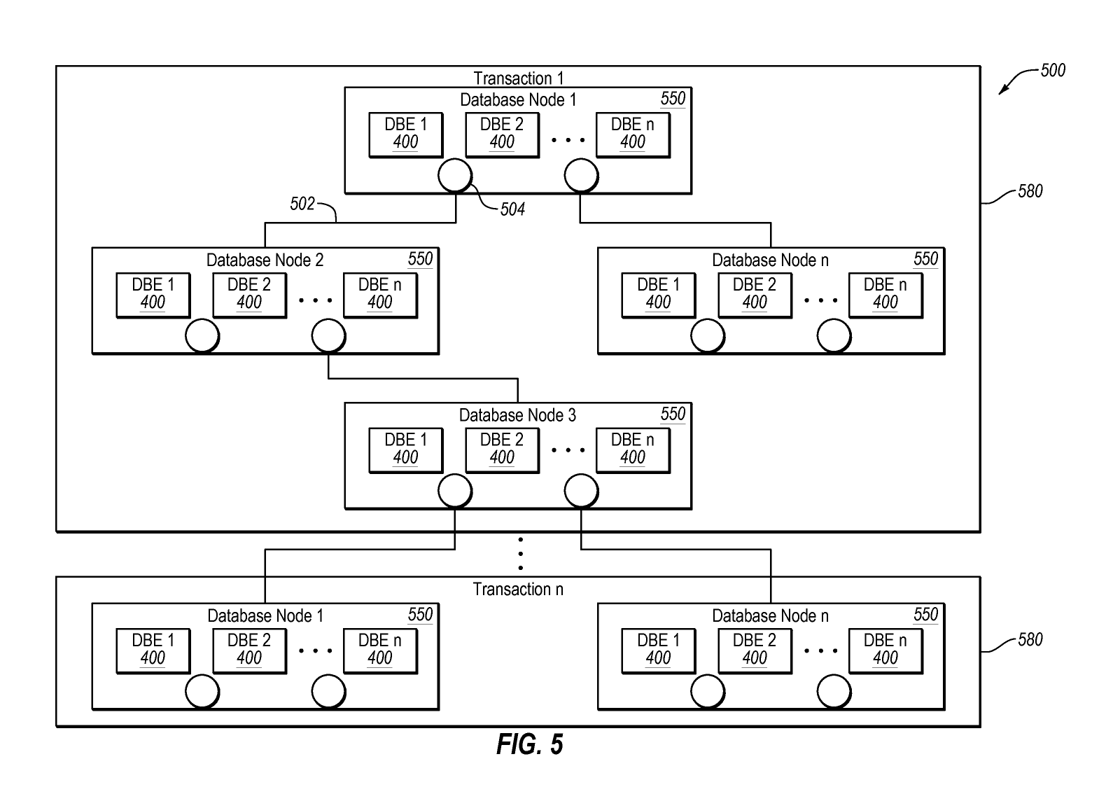

FIG. 4 is a schematic block diagram illustrating an example database element 400. FIG. 5 is a schematic block diagram illustrating an example database 500 configured to track the locations of blocks stored within the example deduplication vault system 102 of FIG. 1. It is understood that although the database 500 is structured as a b-tree of database nodes 550 that are each made up of one or more database elements 400, the database 500 could instead have any other database structure, including an SQL database structure, that is configured to track the locations of blocks stored within the vault storage 108 of FIG. 1.

As disclosed in FIG. 4, each example database element 400 includes a hash field 402 and a location pointer field 404. The hash field 402 identifies a unique block of data in the vault storage 108 of the deduplication vault system 102 of FIG. 1. The hash value stored in the hash field 402 may be a cryptographic hash value between 128 bytes and 512 bytes in length, for example. Alternatively, the hash value stored in the hash field 402 may be a computable check sum, which may allow for better performance with non-aligned writes for example. The hash value can be employed to represent a block of data in a dramatically-compressed data value. For example, a cryptographic hash value of a 4096-byte block may be represented using only 128 bytes. The location pointer field 404 identifies the location in the vault storage 108 where the unique block of data is stored. The location pointer value stored in the location pointer field 404 may be between 38 and 64 bits in length, for example, depending on the total size of the vault storage 108 of FIG. 1.

As disclosed in FIG. 5, the database 500 includes a plurality of database nodes 550. Each database node 550 includes one or more database elements 400. The database elements 400 of a given database node 550 are ordered sequentially based on their hash fields 402 (see FIG. 4). During the initial creation of the database 500, each new database element 400 will be added to a single database node 550, such as the Database Node 1 of Transaction 1. Then, once the single database node 550 has reached a predetermined size, or some other event occurs that results in the finalization of the single database node 550, and when a new database element 400 needs to be added to the database 500, the new database element 400 will be added to a new database node 550, such as the Database Node 2. The new database node 550 will then be linked back to the original database node 550 at a position between two database elements 400 whose hash values surround the hash value of the new database element 400, as illustrated by the link 502 and the position 504 in FIG. 5. This process can be repeated multiple times as the database 500 grows, with each database node 550 potentially having multiple child database nodes 550.

As disclosed in FIG. 5, the database 500 may further be configured to support transactions 580. For example, a first transaction 580 may occur after a certain period of time or after the completion of a certain task or tasks, such as Transaction 1. In one example embodiment, after multiple storages are simultaneously backed up into the vault storage 108 of FIG. 1, a transaction 580 may occur in order to commit the current database 500 to a permanent state where the current database nodes 550 will no longer change. Then, when a new database element 400 needs to be added to the database 500, the new database element 400 will be added to a new database node 550, such as the Database Node 1 of Transaction n. The use of transactions 580 in the modification of the database 500 may enable the separation of backups and may also enable a fail-safe barrier to changes in certain portions of the database 500 after a certain period of time or after the completion of a certain task or tasks.

The database 500 may be employed to search for a given block in the vault storage 108 by traversing the b-tree using the hash value of the given block. Once a database element 400 is found in the database 500 with a hash field 402 that matches the hash value of the given block, the location of the given block in the vault storage 108 can be determined by examining the location pointer field 404 of the database element 400. Similarly, after storing a new block in the vault storage 108, a database element 400 corresponding to the new block can be inserted into the appropriate database node 550 of the database 500 using the hash value of the new block.

FIG. 6 is a schematic block diagram illustrating an example metadata node 600. FIG. 7 is a schematic block diagram illustrating an example metadata 700 configured to track individual backups stored within the example deduplication vault system 102 of FIG. 1. It is understood that although the metadata 700 is structured as a set of metadata records 750 that are each made up of one or more metadata nodes 600, the metadata 700 could instead have any other data structure configured to track the locations of individual base or incremental backups stored within the vault storage 108 of FIG. 1.

As disclosed in FIG. 6, each example metadata node 600 includes a 1st block location pointer field 602 and a run length field 604. The 1st block location pointer field 602 points to the location of the first block of a run in the vault storage 108. The run length field 604 indicates the length of the run that begins at the location pointed to by the 1st block location pointer field 602.

As disclosed in FIG. 7, each metadata record 750 includes one or more metadata nodes 600. Each metadata record 750 may be employed to track a base backup or an incremental backup of the source storage 110, or of any other storage, within the vault storage 108. For example, a first metadata record 750 may be employed to track the base backup of the source storage 110 disclosed in FIG. 3A and a second metadata record 750 may be employed to track the incremental backup of the source storage 110 disclosed in FIG. 3B. The metadata nodes 600 in each metadata record 750 are organized sequentially to match the sequence of blocks of the storage being backed up. Thus, the original location of each run in the source storage 110 is implicitly stored in the metadata record 750 based on the sequential position of the corresponding metadata node 600 in the metadata record 750. The exact offset from the first block in the source storage 110 of a run represented by a given metadata node 600 can be calculated by summing the run length fields 604 of all metadata nodes 600 that precede the given metadata node 600 in the metadata record 750.

For example, a metadata record 750 that represents the first nine blocks of the base backup of the source storage 110 illustrated in FIG. 3A would include six metadata nodes 600 with the following [1st block location pointer field 602, run length field 604] values: [108(2), 1], [Unallocated, 1], [108(7), 2], [108(1), 1], [Unallocated, 1], and [108(3), 3]. In this example, where the 1st block location pointer field 602 has a value of “Unallocated,” this signals that an unallocated run should be inserted during restore. As a second example, another metadata record 750 that represents the first nine blocks included in the incremental backup of the source storage 110 illustrated in FIG. 3B will include six metadata nodes 600 with the following [1st block location pointer field 602, run length field 604] values: [Skip, 3], [108(10), 1], [Skip, 1], [108(11), 1], [Skip, 2], and [108(6), 1]. In this second example, where the 1st block location pointer field 602 has a value of “Skip,” this signals that the indicated run should be skipped over without alteration during restore. Using the two metadata records 750 in these two examples, the data from the source storage 110 can be restored to the state at time t(1) by applying the backups from oldest to newest, namely, first applying the metadata record 750 corresponding to the base backup and then applying the metadata record 750 corresponding to the incremental backup.

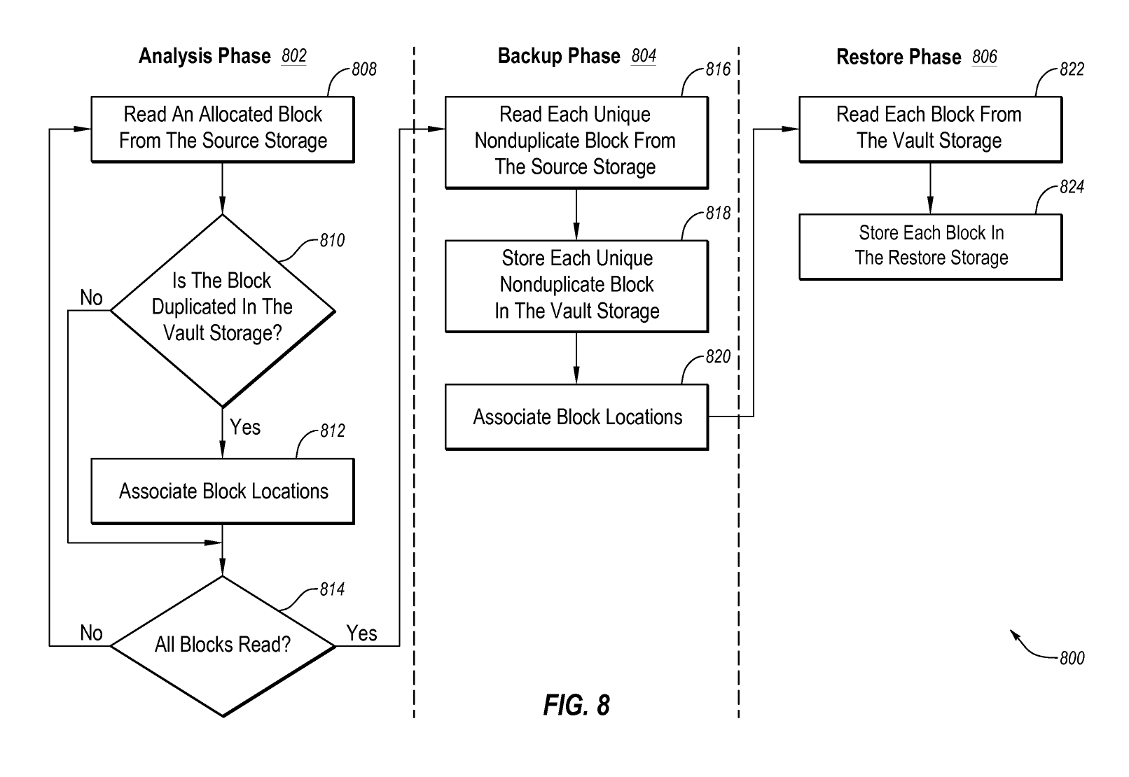

FIG. 8 is a schematic flowchart diagram of an example method 800 of multiphase deduplication. The method 800 may be implemented, in at least some embodiments, by the deduplication module 118 of the deduplication vault system 102 of FIG. 1. For example, the deduplication module 118 may be configured to execute computer instructions to perform operations of multiphase deduplication during the creation of a backup of the source storage 110, as represented by one or more of phases 802-806 which are made up of the steps 808-824 of the method 800. Although illustrated as discrete phases and steps, various phases/steps may be divided into additional phases/steps, combined into fewer phases/steps, or eliminated, depending on the desired implementation. The method 800 will now be discussed with reference to FIGS. 1, 3A, and 8.

The method 800 of multiphase deduplication includes at least two distinct phases that are performed during the creation of a backup of the source storage 110, namely, an analysis phase 802 and a backup phase 804. The performance and completion of the analysis phase 802 prior to the performance of the backup phase 804 may enable decreased fragmentation in the storing of the backup of the source storage 110 in the vault storage 108, resulting in increased efficiency and speed during an optional third restore phase 806 in which the backup of the source storage 110 is restored to a restore storage 112.

The analysis phase 802 of the method 800 may begin at step 808, in which an allocated block is read from a source storage. For example, the deduplication module 118 may read an allocated block 110(1) from the source storage 110.

At decision step 808 of the analysis phase 802, it is determined whether the block is duplicated in a vault storage. For example, the deduplication module 118 may calculate a hash value of the block 110(1) and then use the hash value to query the database 500 of the deduplication vault system 102 to determine whether a database element 400 exists with a matching hash value in the hash field 402 (see FIGS. 4 and 5). If a matching database element 400 does exist, it is determined that the block is duplicated in the vault storage 108 (Yes at step 808). If a matching database element 400 does not exist, it is determined that the block is not duplicated in the vault storage 108.

If it is determined at step 810 that the block is duplicated in the vault storage 108 (Yes at step 810), then the method 800 proceeds to step 812 of the analysis phase 802 where the location of the block on the source storage is associated with the location of the duplicated block on the vault storage. Otherwise (No at step 810), the method 800 proceeds to step 814 of the analysis phase 802.

For example, where the current block is block 110(1), at step 810 it would be determined that the block 110(1) is duplicated in block 108(2) of the vault storage 108. The deduplication module 118 may then associate, at step 812, the block 110(1) from the source storage 110 with the duplicated block 108(2) in the vault storage 108 by creating a metadata node 600 in a metadata record 750 of the metadata 700 that corresponds to the source storage 110 (see FIGS. 6 and 7). The metadata node 600 will include “108(2)” in the 1st block location pointer field 602 and “1” in the run length field 604. The location of the block 110(1) in the source storage 110 will be associated with the metadata node 600 by placing the metadata node 600 in the first sequential position in the corresponding metadata record 750, which implicitly indicates that the metadata node 600 corresponds to the first location of the source storage 110. It is noted that as the analysis phase 802 continues on, the run length field 604 of any given metadata node 600 may be incremented to represent that additional blocks of the corresponding run are stored in the vault storage 108.

In another example, where the current block is block 110(3), at step 810 it would be determined that the block 110(3) is not yet duplicated in the vault storage 108. Where a block is determined at step 810 to not be duplicated in the vault storage 108 (No at step 810), a placeholder metadata node 600 may be created in the metadata record 750 of the metadata 700 that corresponds to the source storage 110 (see FIGS. 6 and 7). This placeholder metadata node 600 may initially include “Null” in the 1st block location pointer field 602 and “1” in the run length field 604. The “Null” value indicates that the block has not yet been duplicated in the vault storage 108. The 1st block location pointer field 602 of this placeholder metadata node 600 may be updated at step 820 once the block has been stored in the vault storage 108, as discussed below. Further, a placeholder database element 400 may be created in the database 500 (see FIGS. 4 and 5). This placeholder database element 400 may initially include the calculated hash value of the block in the hash filed 402 and a “Null” in the location pointer field 404. The “Null” value indicates that the block has not yet been duplicated in the vault storage 108. The location pointer field 404 of this placeholder database element 400 may be updated at step 818 once the block has been stored in the vault storage 108, as discussed below.

In decision step 814 of the analysis phase 802, it is determined whether all of the allocated blocks have been read from the source storage. For example, the deduplication module 118 may determine whether all of the allocated blocks have been read from the source storage 110 in FIG. 3A. If it is determined at step 814 that all allocated blocks have not been read from the source storage 110 (No at step 814), then the method 800 returns to step 808 where the next allocated block is read from the source storage 110. Otherwise, if it is determined at step 814 that all allocated blocks have been read from the source storage 110 (Yes at step 814), then the method 800 proceeds to step 816 of the backup phase 804.

By the conclusion of the analysis phase 802, it will have been determined which allocated blocks from the source storage have already been duplicated in the vault storage and which allocated blocks have not yet been stored in the vault storage. This determination may enable runs of nonduplicate blocks from the source storage to be strategically stored in the backup of the vault storage with little or no fragmentation of the runs. This maintenance of runs in a backup may be particularly useful during the subsequent restore phase 806 because it reduces the time spent seeking the blocks that make up the backup of the source storage, as discussed in greater detail below.

At step 816 of the backup phase 804, each unique nonduplicate block is read from the source storage and at step 818 of the backup phase 804, each unique nonduplicate block is stored in the vault storage. For example, the deduplication module 118 may read each unique nonduplicate block from the source storage 110 and then store each unique nonduplicate block in the vault storage 108. In one example, the run 110(3)-110(4) of the source storage 110 may be read and stored together in the run 108(7)-108(8) of the vault storage 108, and the run 110(7)-110(9) may be read and stored together in the run 108(3)-108(5). Upon each block being stored in the vault storage 108, a database element 400 may be created in the database 500, or a placeholder database element 400 that was previously created in the database 500 at step 810 may be updated, to include the hash value of the block and the location of the block in the vault storage 108 (see FIGS. 4 and 5). The hash value calculated at step 810 may be reutilized so that the hash value of each block is only calculated once.

At step 820 of the backup phase 804, the location of each unique nonduplicate block in the source storage is associated with the location of the corresponding block in the vault storage. For example, the deduplication module 118 may associate the run 110(3)-110(4) of the source storage 110 with the corresponding run 108(7)-108(8) of the vault storage 108 by updating the placeholder metadata node 600 that was created at step 812 in the metadata record 750 of the metadata 700 that corresponds to the source storage 110 (see FIGS. 6 and 7). The metadata node 600 will include “108(7)” in the 1st block location pointer field 602 and “2” in the run length field 604. The location of the run 110(3)-110(4) will be associated with the previously-created placeholder metadata node 600 because the metadata node 600 will have been placed in the appropriate sequential position in the corresponding metadata record 750.

In another example, the deduplication module 118 may associate the run 110(7)-110(9) of the source storage 110 with the corresponding run 108(3)-108(5) of the vault storage 108 by updating the placeholder metadata node 600 that was created at step 812 in the metadata record 750 of the metadata 700 that corresponds to the source storage 110 (see FIGS. 6 and 7). The metadata node 600 will include “108(3)” in the 1st block location pointer field 602 and “3” in the run length field 604. The location of the run 108(3)-108(5) will be associated with the previously-created placeholder metadata node 600 because the metadata node 600 will have been placed in the appropriate sequential position in the corresponding metadata record 750.

By the conclusion of the backup phase 804, a base backup of the source storage will have been stored in the vault storage. Unlike a standard base backup image, however, the backup of the source storage as stored in the vault storage will likely have been reduced in size due to the elimination of duplicate blocks within the base backup. In addition, where multiple storages are backed up into the vault storage, the total overall size of the backups will likely be reduced in size due to the elimination of duplicate blocks across the backups.

It is noted that the analysis phase 802 and the backup phase 804 can also be employed to create an incremental backup of a storage. For example, an incremental phase may include performing at a second point in time t(1), after completion of the initial backup phase 804, a subsequent analysis phase 802 and a subsequent backup phase 804 for only those allocated blocks in the source storage 110 that changed between the point in time t(0) and the second point in time t(1).

At some point in time after the creation of a backup of the source storage 110, the optional restore phase 806 of the method 800 may be performed in order to restore the backup onto a storage, such as the restore storage 112.

At step 822 of the restore phase 806, each allocated block that was stored in the source storage at the point in time is read from the vault storage and, at step 824, each allocated block that was stored in the source storage at the point in time is stored in the restore storage. For example, the deduplication module 118 may read each allocated block that was stored in the source storage 110 at time t(0) from the vault storage 108 and store the blocks in the restore storage 112 in the same position as stored in the source storage 110 at time t(0). For example, at the completion of step 824, the blocks of the restore storage 112 should be identical to the blocks of the source storage 110 disclosed in FIG. 3A.

During the step 822 of the restore phase 806, the previous maintenance of runs in the backup, which was made possible by the completion of the analysis phase 802 prior to the backup phase 804, may reduce the number of seek operations because reading each run only requires a single seek operation. Reducing the number of seek operations reduces the total time spent seeking the blocks during the reading of the blocks at step 822, thus resulting in increased efficiency and speed during the restore phase 806.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological steps, it is to be understood that the subject matter defined in the appended claims is not necessarily limited to the specific features or steps described above. Rather, the specific features and steps described above are disclosed as example forms of implementing the claims.

As used herein, the term “module” may refer to software objects or routines that execute on a computing system. The different modules described herein may be implemented as objects or processes that execute on a computing system (e.g., as separate threads). While the system and methods described herein are preferably implemented in software, implementations in hardware or a combination of software and hardware are also possible and contemplated.

All examples and conditional language recited herein are intended for pedagogical objects to aid the reader in understanding the example embodiments and the concepts contributed by the inventor to furthering the art, and are to be construed as being without limitation to such specifically-recited examples and conditions.

6. The method as recited in claim 1, further comprising an incremental phase that includes performing at a second point in time, after completion of the backup phase, a subsequent analysis phase and a subsequent backup phase for only those allocated blocks in the source storage that changed between the point in time and the second point in time.

7. The method as recited in claim 1, wherein the vault storage is connected to the source storage over the internet.

8. A non-transitory computer-readable medium storing a program that causes a processor to execute the method as recited in claim 1.

9. A method of multiphase deduplication, the method comprising:
an analysis phase that includes performing the following steps for each of multiple allocated blocks stored in a source storage at a point in time:
reading the block from the source storage;
determining whether the block is duplicated in a vault storage; and
associating a location of the block stored in the source storage with a location of the corresponding duplicated block stored in the vault storage if the block is duplicated in the vault storage; and
a backup phase that includes performing, after completion of the analysis phase, the following steps for each unique nonduplicate block stored in the source storage:
reading the block from the source storage;
storing the block in the vault storage; and
associating a location of the block stored in the source storage with a location of the corresponding block stored in the vault storage.

10. The method as recited in claim 9, further comprising a restore phase that includes performing, after completion of the backup phase, the following steps for each of the multiple allocated blocks that was stored in the source storage at the point in time:
reading the block from the vault storage; and
storing the block in a restore storage in the same position as stored in the source storage at the point in time.

11. The method as recited in claim 9, wherein the step of storing the block in the vault storage includes storing, in the vault storage, at least some runs of unique nonduplicate blocks in the same sequence as stored in the source storage at the point in time.

12. The method as recited in claim 9, further comprising an incremental phase that includes performing at a second point in time, after completion of the backup phase, a subsequent analysis phase and a subsequent backup phase for only those allocated blocks in the source storage that changed between the point in time and the second point in time.

13. A non-transitory computer-readable medium storing a program that causes a processor to execute the method as recited in claim 9.

14. A method of multiphase deduplication, the method comprising:
an analysis phase that includes performing the following steps for each of multiple allocated blocks stored in a source storage at a point in time:
reading the block from the source storage;
determining whether the block is duplicated in a vault storage; and
associating a location of the block stored in the source storage with a location of the corresponding duplicated block stored in the vault storage if the block is stored in the vault storage; and
a backup phase that includes performing, after completion of the analysis phase, the following steps for all unique nonduplicate runs in the source storage:
reading the runs from the source storage;
storing the runs in the vault storage in the same sequence as stored in the source storage at the point in time; and
associating a location of each run stored in the source storage with a corresponding location of the run stored in the vault storage.

15. The method as recited in claim 14, wherein the step of determining whether the block is duplicated in the vault storage includes performing a cryptographic hash function on the block to calculate a cryptographic hash value corresponding to the block and comparing the cryptographic hash value against all other cryptographic hash values corresponding to the blocks that are stored in the vault storage.

16. The method as recited in claim 15, wherein the backup phase further includes performing a step of adding the cryptographic hash value corresponding to each unique nonduplicate block to a data structure of cryptographic hash values corresponding to the blocks that are stored in the vault storage.

17. The method as recited in claim 14, wherein the locations associated during the associating steps are stored in a vault data structure.

18. The method as recited in claim 17, further comprising a restore phase that includes performing, after completion of the backup phase, the following steps for each of the runs that was stored in the source storage at the point in time:
accessing the vault data structure to determine the location of the run stored in the vault storage;
reading the run from the determined location in the vault storage; and
storing the run in a restore storage in the same position as stored in the source storage at the point in time.

19. The method as recited in claim 14, further comprising an incremental phase that includes performing at a second point in time, after completion of the backup phase, a subsequent analysis phase and a subsequent backup phase for only those allocated blocks in the source storage that changed between the point in time and the second point in time.

20. A non-transitory computer-readable medium storing a program that causes a processor to execute the method as recited in claim 14.
